(19) United States
(12) Patent Application Publication
(10) Pub. No.: US 2008/0095281 A1
(43) Pub. Date: Apr. 24, 2008

(54) MIMO decoding

(76) Inventors: Srinath Hosur, Plano, TX (US); Michael O. Polley, Garland, TX (US); Anuj Batra, Dallas, TX (US); Manish Goel, Plano, TX (US)

Correspondence Address: TEXAS INSTRUMENTS INCORPORATED, P O BOX 655474, M/S 3999, DALLAS, TX, 75265, US

(21) Appl. No.: 11/323,746

(22) Filed: Dec. 30, 2005

Related U.S. Application Data
(60) Provisional application No. 60/640,904, filed on Dec. 30, 2004.

(51) Int. Cl. H04B 7/10; H04L 1/02

(52) U.S. Cl. 375/347

(57) ABSTRACT

In a wireless MIMO system with interference cancellation, compensate for decision errors in the cancelled symbols by adjustments to the scaling of the soft estimates with additive interference-proportional to estimates of the decision error probability.

### CROSS-REFERENCE TO RELATED APPLICATIONS

This application claims priority from provisional application No.: 60/640,904, filed Dec. 30, 2004.

### BACKGROUND OF THE INVENTION

The present invention relates to communication systems, and more particularly to multiple-input multiple-output wireless systems.

Wireless communication systems typically use band-limited channels with time-varying (unknown) distortion and may have multi-users (such as multiple clients in a wireless LAN). This leads to intersymbol interference plus multi-user interference, and requires interference-resistant detection for systems which are interference limited. Interference-limited systems include multi-antenna systems with multi-stream or space-time coding which have spatial interference, multi-tone systems, TDMA systems having frequency selective channels with long impulse responses leading to intersymbol interference, CDMA systems with multi-user interference arising from loss of orthogonality of spreading codes, high data rate CDMA which in addition to multi-user interference also has intersymbol interference.

Interference-resistant detectors commonly invoke one of three types of equalization to combat the interference: maximum likelihood sequence estimation, (adaptive) linear filtering, and decision-feedback equalization. However, maximum likelihood sequence estimation has problems including impractically large computation complexity for systems with multiple transmit antennas because the decoding requires a search over the topological product of multiple copies of the symbol constellation. Linear filtering equalization, such as linear zero-forcing (ZF) and linear minimum squared error (MMSE) equalization, has lower computational complexity (search over a single symbol constellation) but has relatively poor performance due to excessive noise enhancement. And decision-feedback (iterative) detectors, such as iterative ZF and iterative MMSE, decode the transmitted symbols successively, depending upon an ordering (such as SINR). That is, the ZF or MMSE detector provides an ordering; next, the first (ordered) symbol is decoded; and then the resulting symbol hard decision is subtracted from the input signal to yield a first-symbol-interference-cancelled signal. The ZF or MMSE detector is then applied to this intereference-cancelled signal to find a second symbol to decode. The process is repeated until all of the symbols are decoded. Such methods have moderate computational complexity but only moderate performance.

Sphere decoding, like maximum likelihood decoding, searches in the product of copies of the symbol constellation, but restricts the search to a small sphere about the received signal. The main drawback of sphere decoding is the choice of the radius of the sphere which determines the search space. This radius has to be chosen carefully not to include either too many or too few points. If too few points are included, the performance suffers; while the complexity grows with the number of points included. Sphere decoding also suffers from the problem that the latency and the complexity of decoding is not fixed and could vary from symbol vector to symbol vector and, depending upon the choice of the radius, it could be as high as the maximum likelihood method.

However, these methods have problems of limited tradeoff of performance and complexity.

### SUMMARY OF THE INVENTION

The present invention provides detectors and detection methods for MIMO systems with restricted tree searching.

First preferred embodiments use a triangularizing transform to simplify error computations for tree branches.

This has advantages including high performance detection but with lower complexity.

### BRIEF DESCRIPTION OF THE DRAWINGS

FIG. 1 is a flowchart.

FIGS. 2a-2c illustrate functional blocks of detectors, receivers, and transmitters.

FIGS. 3a-3b show 2×2 MIMO OFDM transmitter and receiver.

FIGS. 4a-4c are search tree diagrams.

FIGS. 5a-5b are simulation results.

### DESCRIPTION OF THE PREFERRED EMBODIMENTS

### 1. Overview

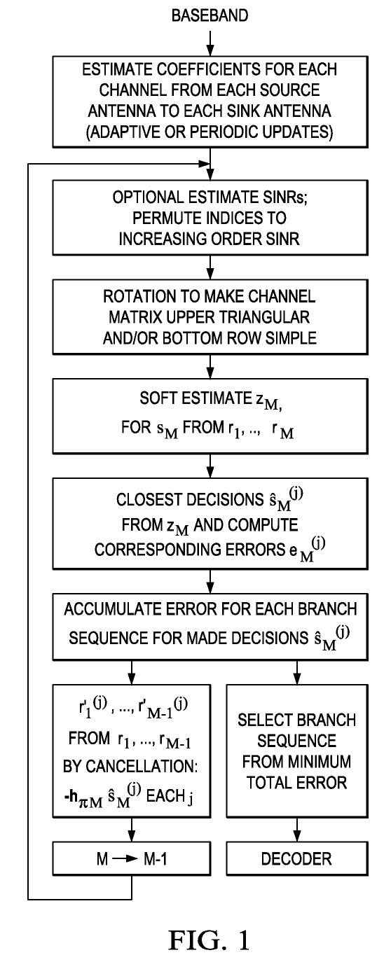

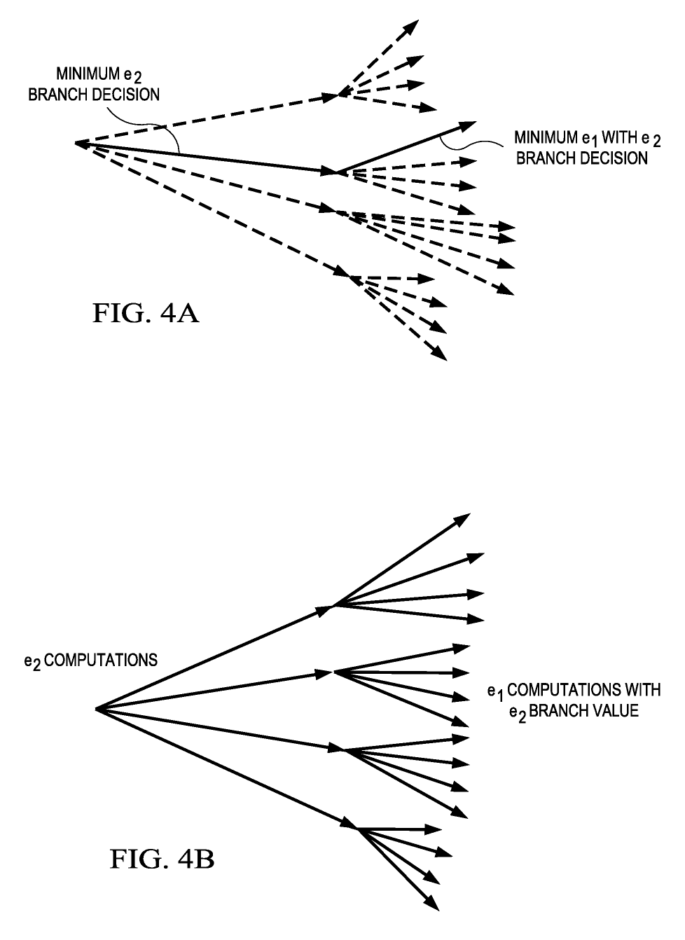

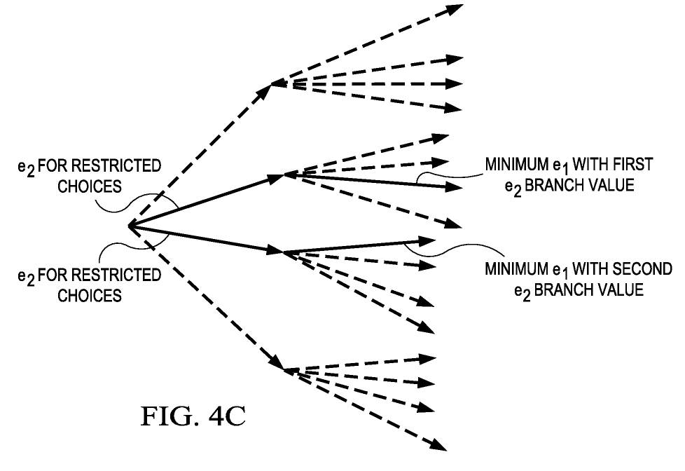

Preferred embodiment detectors and detection methods for multi-input, multi-output (MIMO) systems apply (successive) rotation(s) of received signal vectors to provide detection as a tree-based search, and restriction in the search range lowers computational complexity; FIG. 1 is a flowchart. A rotation to triangularize the channel matrix decouples the received symbols for sequential error computations and back substitutions. This provides interference cancellation and performance improvements over iterative methods such as zero-forcing (IZF) and minimum mean squared error (IMMSE) together with lower computational complexity than maximum likelihood (ML) detection. FIGS. 4a-4b illustrate iterative and maximum likelihood detections, respectively, expressed as tree searches; and FIG. 4c contrasts a preferred embodiment detection.

Preferred embodiment communication systems, such as wireless local area networks, include preferred embodiment detectors and receivers employing preferred embodiment detection methods. The computations can be performed with digital signal processors (DSPs) or general-purpose programmable processors and/or application specific circuitry (ASICs) and/or systems on a chip such as both a DSP, ASIC, and RISC processor on the same chip with the RISC processor control. Analog-to-digital converters and digital-to-analog converters provide coupling to the real world, and modulators and demodulators (plus antenna front ends for air interfaces) provide coupling for transmission waveforms.

### 2. MIMO Detection Generally

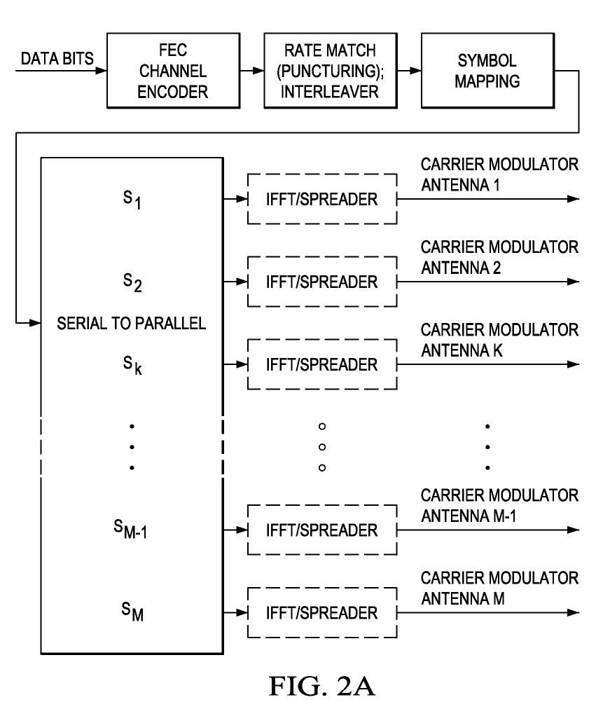

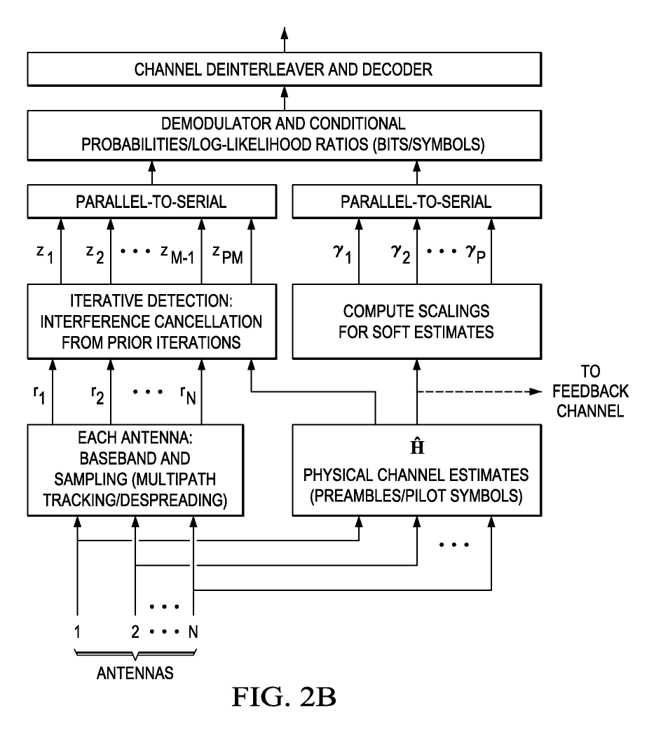

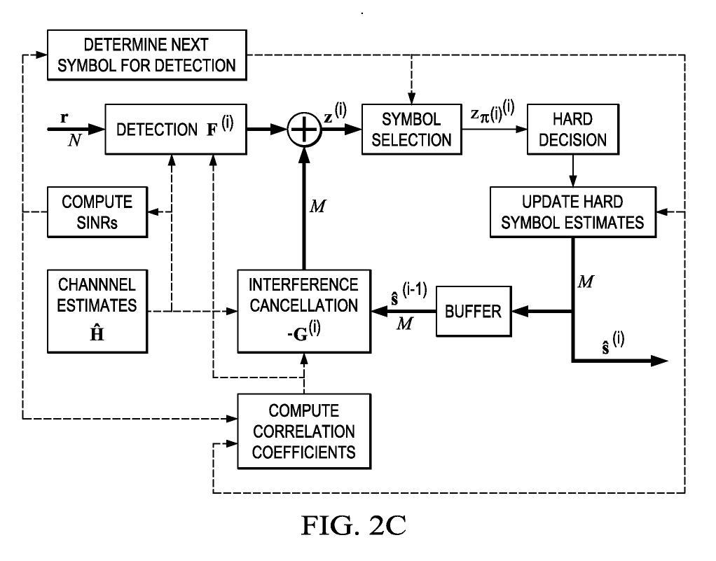

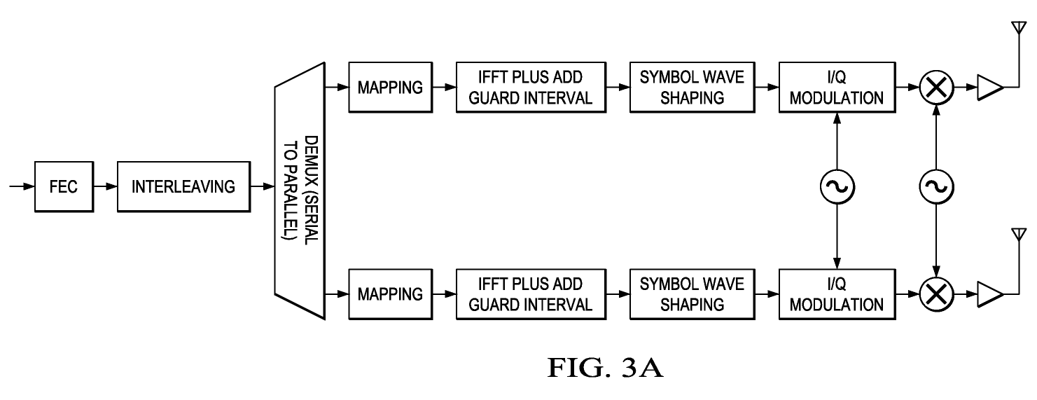

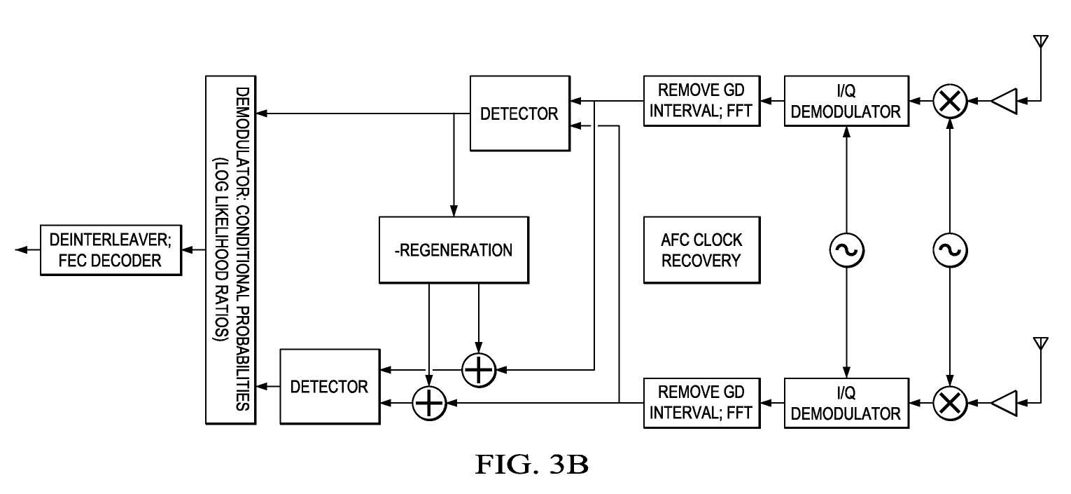

FIG. 2a illustrates a generic MIMO transmitter, and FIG. 2b illustrates a MIMO receiver with an interference-resistant detector; these could be part of a wireless communications system with M transmit antennas (M data streams) and N receive antennas. The received signal in such a system can be written as:

r=Hs+v

where r is the N-vector of samples of the received baseband signal (complex numbers) corresponding to a transmission time (interval) n:

$$r = [ \begin{matrix}{r}_{1} ( n ) \\ {r}_{2} ( n ) \\ ⋮ \\ {r}_{N} ( n )\end{matrix} ]$$

s is the M-vector of transmitted symbols (sets of complex numbers from symbol constellations) for time n:

$$s = [ \begin{matrix}{s}_{1} ( n ) \\ {s}_{2} ( n ) \\ ⋮ \\ {s}_{M} ( n )\end{matrix} ]$$

H is the N×M channel matrix of attenuations and phase shifts expressed as complex numbers; and v is an N-vector of samples of received (white) noise. That is, the (q,p)th element of H is the channel (including multipath combining and equalization) from the pth transmit source to the qth receive sink, and the qth element of v is the noise seen at the qth receive sink.

Note that the foregoing relation applies generally to various systems with various interference problems and in which n, r, s, M, and N have corresponding interpretations. For example:

(i) High data rate multi-antenna systems such as BLAST (Bell Labs layered space time) or MIMO and multi-stream space-time coding: spatial interference suppression techniques are used in detection.
(ii) Broadband wireless systems employing OFDM (orthogonal frequency division multiplex) signaling and MIMO techniques for each tone or across tones.
(iii) TDMA (time division multiple access) systems having frequency-selective channels with long impulse response which causes severe ISI (intersymbol interference); use equalizers to mitigate ISI.
(iv) CDMA (code division multiple access) systems having frequency-selective channels which cause MUI (multi-user interference) as a result of the loss of orthogonality between spreading codes. For high data rate CDMA systems such as HSDPA and 1×EV-DV, this problem is more severe due to the presence of ISI. Equalizers and/or interference cancellation may be used to mitigate these impairments.
(v) Combinations of foregoing.

M is essentially the number of symbols that are jointly detected as they interfere with one another, and N is simply the number of collected samples at the receiver. Because there are M independent sources, N must be at least as large as M to separate the M symbols. A detector in a receiver as in FIGS. 2a-2b outputs soft estimates z of the transmitted symbols s to a demodulator and decoder.

Maximum likelihood (ML) detection estimates the transmitted M-vector of symbols as that vector which minimizes the error between the received N-vector signal, r, and the estimated-channel-matrix-H-computed transmitted signal, Hs:

ŝ_{ML}=arg{min_{sεΠC}(∥r−Hs∥²)}

where sεΠC indicates the minimization is over all M-vectors s which are elements of the product of the symbol constellations for the transmitters. The following sections will recast ML detection as a tree detection (FIG. 4b) in order to contrast the preferred embodiment detections.

Linear filtering equalization detectors, such as linear zero-forcing (LZF) or linear minimum mean square error (LMMSE), make soft estimates, denoted by M-vector z, for the transmitted M-vector of symbols, s, from the N-vector of received signals, r, by linear filtering with an M×N matrix: z=Fr. Then quantization (hard decision) of z yields the transmitted symbol vector estimate: ŝ=Q(z). LZF detection essentially takes F to be the pseudoinverse of H; namely, F=[H^{H}H]⁻¹ H^{H}, where ^{H} denotes Hermitian conjugate. Note that F reduces to the inverse, H⁻¹, for an invertible (square) matrix H.

In contrast, LMMSE detection finds the matrix F by minimizing the mean squared error in the product space of the symbol constellations, E[∥z−s∥²]. With perfect estimation of the channel H, the minimizing matrix F is given by:

F=[H^{H}H+Σ]⁻¹H^{H}

where Σ is the covariance matrix of the additive white noise v. Note F has the form of a matrix product of an equalization matrix with the matched filter for the channel (H^{H}).

FIG. 2c illustrates linear detection with interference cancellation; namely, hard decisions are made sequentially on the set of M symbols detected with each hard decision used to regenerate an estimate of the interference from that symbol to subtract for redetection of the remaining symbols. The order of hard decisions may be based on the symbol post-detection signal-to-interference-plus-noise ratio (SINR); this helps reduce the effect of decision feedback error. In particular, let the detection order be π(1), π(2), . . . , π(M) where π( ) is a permutation of the M integers {1,2, . . . ,M}; that is, the first estimated symbol (hard decision output) will be ŝ_{π(l)}. The maximum SINR among the components of the first soft M-vector estimate z⁽¹⁾, which estimates all M symbols, determines π(1). Similarly, the SINRs of the components of z⁽²⁾, which estimates all of the symbols except the cancelled s_{π(1)}, determines π(2), and so forth. That is, the ith iteration estimates symbol s_{π(i)}, and modifying the foregoing to accommodate the ordering is routine but omitted for clarity in notation. Indeed, simply denote the resulting M soft symbol estimates as z₁, z₂, . . . , z_{M}. Note that the interference cancellation steps can be interpreted as either sequentially deleting columns from the channel matrix H and components from the symbol vector s to yield successively smaller systems, or as sequentially zeroing out columns of the channel matrix. In both cases the received signal vector sequentially has the interference vectors subtracted.

### 3. 2×2 Preferred Embodiments

The preferred embodiment detections can be explained in terms of a restricted tree search; thus express the foregoing detection methods (ML plus linear and iterative ZF/MMSE) in terms of tree searches in order to contrast the preferred embodiments. For ease of explanation, initially consider a 2×2 system; FIGS. 4a-4c will illustrate the corresponding tree searches for a constellation of four symbols such as QPSK.

First, note that the foregoing detection methods are invariant under rotation in the received signal space. In particular, if U is a unitary matrix (U^{H}U=I), then ∥r−Hs∥²=<r−Hs|r−Hs>=<r−Hs|U^{H}U(r−Hs)>=<U(r−Hs)|U(r−Hs)>=∥\tilde{r}−\tilde{H}s∥² where \tilde{H}=UH, \tilde{r}=Ur, and <.|.> denotes inner (scalar) product. Analogously, F_{ZF}r=[H^{H}H]⁻¹ H^{H}r=[H^{H}U^{H}UH]⁻¹ H^{H}U^{H}Ur=[(UH)^{H}(UH)]^{31 1} (UH)^{H}Ur=[\tilde{H}^{H}\tilde{H}]⁻¹ \tilde{H}^{H}\tilde{r}=\tilde{F}_{ZF}\tilde{r}. Similarly for MMSE, [H^{H}H+Σ]⁻¹ H^{H}r=[\tilde{H}^{H}\tilde{H}+Σ]⁻¹ \tilde{H}^{H}\tilde{r}.

For a 2×2 system:

$$\begin{matrix}r = [ \begin{matrix}{r}_{1} \\ {r}_{2}\end{matrix} ] \\ = Hs + v \\ = [ \begin{matrix}{h}_{11} & {h}_{12} \\ {h}_{21} & {h}_{22}\end{matrix} ] [ \begin{matrix}{s}_{1} \\ {s}_{2}\end{matrix} ] + [ \begin{matrix}{v}_{1} \\ {v}_{2}\end{matrix} ] \\ = [ \begin{matrix}{h}_{1} & {h}_{2}\end{matrix} ] [ \begin{matrix}{s}_{1} \\ {s}_{2}\end{matrix} ] + v\end{matrix}$$

where

$${h}_{1} = [ \begin{matrix}{h}_{11} \\ {h}_{21}\end{matrix} ] and {h}_{2} = [ \begin{matrix}{h}_{12} \\ {h}_{22}\end{matrix} ] .$$

Now find a rotation (2×2 unitary) matrix U which makes the 2×2 product matrix UH a triangle matrix (a lower left element equal to 0); that is:

$$\tilde{H} = [ \begin{matrix}{\tilde{h}}_{11} & {\tilde{h}}_{12} \\ 0 & {\tilde{h}}_{22}\end{matrix} ]$$

For example, U could be:

$$U = c [ \begin{matrix}1 & {h}_{21}^{*} / {h}_{11}^{*} \\ - {h}_{21} / {h}_{11} & 1\end{matrix} ]$$

where c is the normalization: c²=1/(1+|h₂₁/h_{11|}²).

In general, a triangle channel matrix allows for simple system solutions by successive component solutions plus back substitutions; this provides a simple interference cancellation. In particular, first transform the 2×2 system by left-multiply the equation r=Hs+v with U to obtain a 2×2 triangular system:

$$\begin{matrix}\tilde{r} = Ur \\ = U ( Hs + v ) \\ = \tilde{H} s + \tilde{v} \\ = [ \begin{matrix}{\tilde{h}}_{11} & {\tilde{h}}_{12} \\ 0 & {\tilde{h}}_{22}\end{matrix} ] s + \tilde{v}\end{matrix}$$

### Because U is unitary, \tilde{v} is still additive white noise.

LZF finds soft estimate z for s by left-multiplying \tilde{r} with \tilde{F}_{ZF} (which is the left inverse of \tilde{H}):

$$z = {\tilde{F}}_{ZF} \tilde{r} = {\tilde{H}}^{- 1} \tilde{r} = [ \begin{matrix}1 / {\tilde{h}}_{11} & - {\tilde{h}}_{12} / {\tilde{h}}_{11} {\tilde{h}}_{22} \\ 0 & 1 / {\tilde{h}}_{22}\end{matrix} ] \tilde{r}$$

### So the LZF soft estimates are z₂=\tilde{r}₂/\tilde{h}₂₂ and z₁=\tilde{r}₁/\tilde{h}₁₁−\tilde{r}₂/\tilde{h}₁₂/\tilde{h}₁₁\tilde{h}₂₂.

Iterative ZF detection (with symbols detected in reverse index order) finds ŝ₂ by a quantization (hard decision) of z₂=\tilde{r}₂/\tilde{h}₂₂, and then back-substitutes this ŝ₂ to cancel its estimated contribution, \tilde{h}₂ŝ₂, from the received signal, \tilde{r}, to have \tilde{r}′=\tilde{r}−\tilde{h}₂ŝ₂. This defines a system for s₁ by deleting the second column from the H matrix (which corresponds to s₂ propagation) and deleting the corresponding second component (row) of the symbol vector s corresponding to s₂. This yields a 2×1 system for the remaining symbol s₁. (The second component (row) is trivial and is just the noise because the channel matrix is triangular; this row could also be deleted to yield a 1×1 system.) Then solve for the soft estimate, z₁, of the first symbol, s₁

z₁=\tilde{r}₁′/\tilde{h}₁₁=\tilde{r}₁/\tilde{h}₁₁−\tilde{h}₁₂ŝ₂/\tilde{h}₁₁.

Lastly, quantize z₁ to complete the hard decision output (ŝ₁, ŝ₂) of a decoder. Alternatively, the soft estimates (z₁, z₂) could be output to a sequence decoder.

The LMMSE and the iterative MMSE solutions can also be obtained by choosing the appropriate unitary matrix U. Indeed, to have [\tilde{H}^{H}\tilde{H}+Σ]⁻¹ \tilde{H}^{H}=\tilde{F}_{MMSE} as a triangular matrix in the 2×2 case (with Σ diagonal σ²/EI) simply requires a U such that U^{H}=[u₁u₂] satisfies <u₁|h₁>/<u₂|h₂>=detHσ²/E. Of course, \tilde{H} triangular is the same as <u₂|h₁>=0, but this may not be simultaneously possible with \tilde{F}_{MMSE} triangular.

FIG. 4a illustrates the two steps of the just-described iterative ZF method interpreted as branch choices in a decoding tree for the case of a symbol constellation with four points, such as QPSK. The first step makes the hard decision estimate ŝ₂ by minimizing the s₂ detection error e₂=|\tilde{r}_{-\tilde{h}}₂₂s₂|²; that is, first solve for e₂=0 to get the soft estimate z₂=\tilde{r}₂/\tilde{h}₂₂ then quantize (hard decision) z₂ to get ŝ₂: the quantization picks the constellation point which minimizes the distance to z₂. Next, the second step makes the hard decision estimate ŝ₁ by minimizing the s₁ detection error after back substitution of the first step hard decision, ŝ₂; that is, minimize the error e₁=|(\tilde{r}₁−\tilde{h}₁₂ŝ₂)−\tilde{h}₁₁s₁|² by first solve e₁=0 to find soft estimate z₁=\tilde{r}₁/\tilde{h}₁₁−\tilde{h}₁₂ŝ₂/\tilde{h}₁₁ and then quantize z₁ by minimizing the distance to the constellation to get ŝ₁. In short, at each node there are four branches (corresponding to the four possible values of the single symbol under consideration), and the smallest error branch (solid arrow in FIG. 4a) is chosen which determines the node for the next step branch. The transformation of H into a triangle matrix translates the branches into values of a single symbol.

Note that in FIG. 4a if the second step had been to minimize the error |(\tilde{r}₁−\tilde{h}₁₂\tilde{r}₂/\tilde{h}₂₂)−\tilde{h}₁₁s₁|², then the non-iterative ZF would have been performed; that is, the non-iterative approach uses the soft decision Z₂ instead of the hard decision ŝ₂ in the tree search interpretation.

The maximum likelihood (ML) method also may be interpreted as a tree search but with the minimization of the combined error e₂+e₁ rather than minimizing each of the errors sequentially. This implies that even though ML might choose a branch on the tree for which e₂ is not minimized in the first step, the total error e₂+e₁ could still be minimized with this branch. Indeed, FIG. 4b illustrates the ML search on the tree as considering all combinations of a first branch and a connecting second branch by showing all arrows as solid. This can be summarized as:
1) Compute e₂ for all branches in the first step.
2) For each branch of the first step, compute e₁ for each second branch and choose the second-step branch with the minimum e₁.
3) Compute e₂+e₁ for each of the first-step branches using the second-step branch chosen in step 2). Choose the first-step branch which minimizes the total error e₂+e₁; the second-step branch is the corresponding one from step 2).

Thus the ML method effectively performs an interference cancellation with each of the constellation points as a possible hard decision for the first-step branch. It also computes the first step error for each possibility. And for each such interference cancellation it obtains a possible second-step branch and associated error. It then chooses the hard decisions as from the two branches which minimize the sum of the errors.

The problem with the iterative ZF/MMSE methods is evident from the tree interpretation of ML: if the symbol decision in the first step from the root of the tree in the iterative method is wrong, then this leads to an “error feedback” in the second branch computations. The ML method minimizes the impact of this error feedback by including all of the constellation points as possible candidates in the first step.

The preferred embodiments also perform a tree search, but in contrast to ML and (iterative) ZF/MMSE, the preferred embodiments restrict the number of branches searched on the first step and thereby reduce the complexity of the ML method of full tree searching but still typically search more than one branch to obtain close-to-ML performance. In particular, a first preferred embodiment detection method for the 2×2 triangle system \tilde{r}=\tilde{H}s+\tilde{v} with K₂ branches searched in the first step proceeds as follows:
1) Compute ZF/MMSE weight vectors (\tilde{F}_{ZF}/\tilde{F}_{MMSE}) and thus the soft estimate z₂.
2) Pick the K₂ candidate symbols (constellation points) s₂⁽¹⁾, s₂⁽²⁾, . . . , s₂^{(K}^{₂}⁾ which are closest to the soft estimate z₂, and compute the corresponding error for each of these K₂ constellation points: e₂^{(j)}=|\tilde{r}₂−\tilde{h}₂₂s₂^{(j)}|². For ZF z₂=\tilde{r}₂/\tilde{h}₂₂, but for MMSE z₂ generally depends upon both \tilde{r}₁ and \tilde{r}₂.

There are two possible approaches to the candidate symbols: (1) pick the K₂ symbols, s₂⁽¹⁾, s₂⁽²⁾, . . . , s₂^{(K}^{₂}⁾, which have the smallest distances |z₂−s₂^{(j)}|² in the constellation, and (2) for each symbol in the constellation s₂⁽¹⁾, s₂⁽²⁾, . . . , s₂^{(C)}, compute the corresponding error e₂⁽¹⁾, e₂⁽²⁾, . . . , e₂^{(C)}, and pick the K₂ symbols with the K₂ smallest e₂^{(j)}. The first preferred embodiment methods use of the symbol space errors; alternatives use the received-signal-space errors.

This set of K₂ candidate symbols will include the iterative ZF/MMSE hard decision because the hard decision is the symbol minimizing |z₂−s₂|². These K₂ symbols constitute the restricted search of the first step which then determines the tree nodes for the second step searches. The triangular form of \tilde{H} makes \tilde{r}₂ only depend upon s₂, thus a candidate symbol decision, s₂^{(j)}, allows both a corresponding error computation e₂^{(j)}=|\tilde{r}₂−\tilde{h}₂₂s₂^{(j)}|² because the other symbol, s₁, need not be specified and a back substitution to eliminate the \tilde{r}₂ equation.
3) Perform the interference-cancellation second-step branch search for each of the K₂ branches from step 2). That is, for each of the K₂ first-step branches (candidate symbols s₂⁽¹⁾, s₂⁽²⁾, . . . , s₂^{(K}^{₂}⁾), compute the portion of the received signal due to this s₂^{(j)} and subtract it from the received signal to give a new system for the remaining symbol s₁ with this candidate s₂^{(j)} interference cancelled (\tilde{r}₁^{(j)}=\tilde{r}₁−\tilde{h}₁₂s₂^{(j)} and \tilde{r}₂^{(j)}=\tilde{r}₂−\tilde{h}₂₂s₂^{(j)}). Then find the corresponding second-step iterative ZF/MMSE hard decision ŝ₁^{(j)} by minimizing (with respect to s₁) the corresponding second-step error e₁^{(j)=|((\tilde{r}}₁−\tilde{h}₁₂s₂^{(j)})−\tilde{h}₁₁s₁|² of the second-step branches.
4) Compute the total error e₂^{(j)}+e₁^{(j)} for each of the K₂ first-step branches using results of steps 2) and 3). That is, for each of the K₂ first step branches (s₂⁽¹⁾, s₂⁽²⁾, . . . , s₂^{(K}^{₂}⁾) and associated errors (e₂⁽¹⁾, e₂⁽²⁾, . . . , e₂^{(K}^{₂}⁾) considered in step 2), add the associated minimizing second-step error (e₁⁽¹⁾, e₁⁽²⁾, . . . , e₁^{(K}^{₂}⁾)) computed in step (3). Find the one of the resulting K₂ two-branch paths in the tree which minimizes the total error e₂+e₁; this defines the two-branch path ŝ₂, ŝ₁ as the detected pair of symbols.

The ordering of the computations could be reversed; in fact, a selection of which symbol to consider first (and thus use for cancellation) could be based on the larger received SNR or some other such metric, and the U transform accordingly selected.

The following pseudocode implements interference cancellation for ZF which is used for each candidate in step (3).
H₀=H:r₀=r:C₀=[0,1, . . . ,M]
for m=0:M−1
   ŝₘ=Q([Hₘ^{H}Hₘ)]⁻¹Hₘ^{H}rₘ);
   rₘ₊₁=rₘ−hₖₘŝₖₘ
   Hₘ₊₁=the matrix Hₘ after deletion of fow kₘ
   Cₘ₊₁=the set Cₘ after deletion of index kₘ end

### 4. N×M Preferred Embodiments

The foregoing procedure can be extended to the case of M transmit antennas and N receive antennas (an N×M channel matrix H) with N≧M Two different approaches may be used:
First approach: The rotations to convert H to upper triangular form can be predetermined and accumulated into one matrix U. This matrix is used in step 1). Steps 2) and 3) of the foregoing are repeatedly applied with Kₘ candidate constellation points for each of the Kₘ₋₁ branches until the tree leaves are reached.
Second approach: apply a rotation U_{M} in step 1) to zero out rows N to M of H except for the (M,M) element. Next, perform steps 2) and 3) of the foregoing. Then remove the last column of U_{M}H and the zero rows to yield a new matrix H_{M}. Also strip off the last component (row) of \tilde{r} to obtain a new vector r_{M}. Note that the columns of H_{M} and the corresponding rows of r_{M} can be permuted to change the order of the detected symbols. Steps 1) to 3) are preformed using H_{M} and r_{M} on each of the K_{M} branches. This process is repeated until the end leaf nodes are reached.
   The error metrics are computed for each branch; once the tree leaves are reached, find the minimum from the ΠKₘ accumulated metrics. The branch sequence to which this minimum metric belongs indicates the decoded symbol vector ŝ. This procedure can also be performed with MMSE based rotations instead of the ZF rotations. Indeed, one way to do an MMSE rotation is to first factor [H^{H}H+σ²I] into the product of an M×M lower triangular matrix L and its transpose:

$${H}^{H} H + {σ}^{2} I = {LL}^{T}$$

$$Then$$

$$\begin{matrix}z = {F}_{MMSE} r \\ = {( {LL}^{T} )}^{- 1} {H}^{H} r \\ = {( {L}^{T} )}^{- 1} {L}^{- 1} {H}^{H} r \\ = s + {( {L}^{T} )}^{- 1} [ {L}^{- 1} {H}^{H} r - {L}^{T} s ]\end{matrix}$$

Then apply tree-based decoding: L^{T} is upper triangular, so L^{T} s has the right structure. And the MMSE rotations need not be unitary.

### 5. 4×4 Preferred Embodiment

An explicit 4×4 example will help illustrate these approaches and variants of them. Thus, presume four antennas transmitting symbols s₁, s₂, s₃, s₄ with each symbol from a 16 QAM constellation; the transmissions propagate to four receiver antennas through a channel with 4×4 matrix H.

(1) Initial triangularization preferred embodiments

First, consider the approach of initially triangularizing H and detecting the symbols in order s₄, s₃, s₂, s₁ with four candidate symbols at each step (K₄=K₃=K₂=K₁=4). Thus presume a 4×4 unitary matrix U has been found and applied to triangularize 4×4 system into:

$$[ \begin{matrix}{r}_{1} \\ {r}_{2} \\ {r}_{3} \\ {r}_{4}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34} \\ 0 & 0 & 0 & {h}_{44}\end{matrix} ] [ \begin{matrix}{s}_{1} \\ {s}_{2} \\ {s}_{3} \\ {s}_{4}\end{matrix} ] + [ \begin{matrix}{v}_{1} \\ {v}_{2} \\ {v}_{3} \\ {v}_{4}\end{matrix} ]$$

### Note that if any of the diagonal elements equals 0, then the system is degenerate and all four symbols cannot be detected.

Initial symbol detection. (a) Start with s₄: find the soft estimate z₄ from the linear z=Fr with F either the LZF filter or the LMMSE filter. The LZF filter is simple:

$${F}_{ZF} = [ \begin{matrix}1 / {h}_{11} & - & - & - \\ 0 & 1 / {h}_{22} & - & - \\ 0 & 0 & 1 / {h}_{33} & - \\ 0 & 0 & 0 & 1 / {h}_{44}\end{matrix} ]$$

where the upper off-diagonal elements (cofactors divided by the determinant) are not explicitly shown for clarity. F_{ZF} immediately gives: z₄=r₄/h₄₄. The LMMSE filter, F_{MMSE}, is not as simple and z₄=f₄₁r₁+f₄₂r₂+f₄₃r₃+f₄₄r₄ where [f₄₁,f₄₂,f₄₃,f₄₄] is the fourth row of F_{MMSE}.

(b) Denote by s₄⁽¹⁾, s₄⁽²⁾, s₄⁽³⁾, s₄⁽⁴⁾ the four (K₄=4) candidate symbols in the 16 QAM constellation which are closest to z₄ computed in (a). That is, the four smallest |z₄−s₄|² out of the sixteen possible.

(c) Compute the error corresponding to each of the four candidate symbols from step (b): e₄⁽¹⁾=|r₄−h₄₄s₄⁽¹⁾|², e₄⁽²⁾=|r₄−h₄₄s₄⁽²⁾|², e₄⁽³⁾=|r₄−h₄₄s₄⁽³⁾|², and e₄⁽⁴⁾=|r₄−h₄₄s₄⁽⁴⁾|². The triangular matrix allows this error to avoid dependence on the yet-to-be-considered symbols and thereby greatly reduce complexity.

(d) For each of the four candidate symbols, cancel the interference in r from that candidate symbol to give a new 3×3 system for the remaining symbols s₃, s₂, s₁. That is, delete the fourth component of r and the fourth row of H because they only contained s₄ information and candidates for s₄ have just been chosen; the candidate value is used in s. Thus for each j=1,2,3,4:

$$[ \begin{matrix}{r}_{1} \\ {r}_{2} \\ {r}_{3}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34}\end{matrix} ] [ \begin{matrix}{s}_{1} \\ {s}_{2} \\ {s}_{3} \\ {s}_{4}^{( j )}\end{matrix} ] + [ \begin{matrix}{v}_{1} \\ {v}_{2} \\ {v}_{3}\end{matrix} ]$$

which is the same as:

$$[ \begin{matrix}{r}_{1} - {h}_{14} {s}_{4}^{( j )} \\ {r}_{2} - {h}_{24} {s}_{4}^{( j )} \\ {r}_{3} - {h}_{34} {s}_{4}^{( j )}\end{matrix} ] = [ \begin{matrix}{h}_{11} & {h}_{12} & {h}_{13} \\ 0 & {h}_{22} & {h}_{23} \\ 0 & 0 & {h}_{33}\end{matrix} ] [ \begin{matrix}{s}_{1} \\ {s}_{2} \\ {s}_{3}\end{matrix} ] + [ \begin{matrix}{v}_{1} \\ {v}_{2} \\ {v}_{3}\end{matrix} ]$$

That is, each candidate s₄^{(j)} has an error measure e₄^{(j)} and a 3×3 system for the remaining three symbols. In terms of the tree, each candidate corresponds to a branch from the root node to a first level node, the 3×3 system corresponds to the portion of the tree from the first node to the leaves, and the candidate's error corresponds to the metric for the candidate branch.

Next symbol detection. (a) For s₃ in the 3×3 system corresponding to a condidate s₄^{(j)}: find the soft estimate z₃^{(f)} from the linear z^{(j)}=Fr^{(j)} with F either the LZF filter or the LMMSE filter for the 3×3 triangular matrix and

$${r}^{( j )} = [ \begin{matrix}{r}_{1} - {h}_{14} {s}_{4}^{( j )} \\ {r}_{2} - {h}_{24} {s}_{4}^{( j )} \\ {r}_{3} - {h}_{34} {s}_{4}^{( j )}\end{matrix} ] .$$

(b) Denote by s₃^{(j)(1)}, s₃^{(j)(2)}, s₃^{(j)(3)},s₃^{(j)(4)}the four (K₃=4) candidate symbols in the 16 QAM constellation closest to z₃^{(j)} computed in (a). That is, the four smallest |z₃^{(j)}=s₃|² out of the sixteen possible. Thus there are a total now of sixteen candidate symbols s₃^{(j)(k)} and symbol pairs (s₄^{(j)}, s₃^{(j)(k)}).

(c) Compute the error corresponding to each of the sixteen candidate symbols from (b): e₃^{(j)(k)}=|r₃−h₃₄s₄^{(j)}−h₃₃s₃^{(j)(k)}|². Again, the triangular matrix allows for an error computation without involving the yet-to-be-considered symbols s₂, s₁.

(d) For each of the sixty-four candidate symbols from (b), cancel the interference in r from that candidate symbol to give a new 2×2 system for the remaining symbols s₂, s₁. That is, delete the third component of r and the third row of the 3×3 H because they only contained s₃ information and candidates for s₃ have just been chosen; the candidate value is used in s. Thus for each j=1,2,3,4 and k=1,2,3,4:

$$[ \begin{matrix}{r}_{1} - {h}_{14} {s}_{4}^{( j )} - {h}_{13} {s}_{3}^{( j ) ( k )} \\ {r}_{2} - {h}_{24} {s}_{4}^{( j )} - {h}_{23} {s}_{3}^{( j ) ( k )}\end{matrix} ] = [ \begin{matrix}{h}_{11} & {h}_{12} \\ 0 & {h}_{22}\end{matrix} ] [ \begin{matrix}{s}_{1} \\ {s}_{2}\end{matrix} ] + [ \begin{matrix}{v}_{1} \\ {v}_{2}\end{matrix} ]$$

So each candidate s₃^{(j)(k)} has an error measure and a 2×2 system for the remaining symbols. In terms of the tree, each candidate pair corresponds to a sequence of two branches from the root node to a first level node to a second level node, the 2×2 system corresponds to the portion of the tree from the second level node to the leaves, and the candidate's error corresponds to the metric for the second branch so the sum of errors e₄^{(j)}+e₃^{(j)(k)} corresponds to the metric for the pair of branches. There are sixteen (=K₄K₃) sequences of two branches from the root node to second level nodes.

Third symbol detection. (a) For s₂ in the 2×2 system corresponding to the candidate s₃^{(j)(k)}: find the soft estimate z₂^{(j)(k)} from the linear z^{(f)(k)}=Fr^{(j)(k)} with F either the LZF filter or the LMMSE filter for the 2×2 triangular matrix and

$${r}^{( j ) ( k )} = [ \begin{matrix}{r}_{1} - {h}_{14} {s}_{4}^{( j )} - {h}_{13} {s}_{3}^{( j ) ( k )} \\ {r}_{2} - {h}_{24} {s}_{4}^{( j )} - {h}_{23} {s}_{3}^{( j ) ( k )}\end{matrix} ] .$$

(b) Denote by s₂^{(j)(k)(1)}, s₂^{(j)(k)(2)}, s₂^{(j)(k)(3)}, s₂^{(j)(k)(4)} the four (K₂=4) candidate symbols in the 16 QAM constellation closest to z₂^{(j)(k)} from (a). Thus there are a total now of sixty-four candidate symbols s₂^{(j)(k)(i)} and thus sixty-four candidate symbol triplets (s₄^{(j)}, s₃^{(j)(k)}, s₂^{(j)(k)(i)}).

(c) Compute the error corresponding to each of the sixty-four candidate symbols from (b): e₂^{(j)(k)(i)}=|r₂−h₂₄s₄^{(j)}−h₂₃s₃^{(j)(k)}−h₂₂s₂^{(j)(k)(i)}|². Again, the triangular matrix allows for an error computation without involving the yet-to-be-considered symbol s₁.

(d) For each of the sixty-four candidate symbols from (b), cancel the interference in r from that candidate symbol to give a (trivial) new 1×1 system for the remaining symbol s₁. Thus for each j=1,2,3,4, k=1,2,3,4, and i=1,2,3,4:

r₁−h₁₄s₄^{(j)}−h₁₃s₃^{(j)(k)}−h₁₂s₂^{(j)(k)(i)}=h₁₁s₁+v₁.

So each candidate s₂^{(j)(k)(i)} has an error measure and a trivial 1×1 system for the remaining symbol. In terms of the tree, each candidate triple corresponds to a sequence of three branches from the root node to a first level node to a second level node to a third level node, the 1×1 system corresponds to the portion of the tree from the third level node to the leaves, and the candidate's error corresponds to the metric for the third branch so the sum of errors e₄^{(j)}, e₃^{(j)(k)}, e₂^{(j)(k)(i)} corresponds to the metric for the sequence of three branches. There are sixty-four (=K₄K₃K₂) sequences of three branches from the root node to third level nodes.

Last symbol detection. (a) Each of the sixty-four 1×1 systems for s₁ has a trivial soft estimate z₁^{(j)(k)(i)}=r₁^{(j)(k)(i)}/h₁₁=r₁−h₁₄s₄^{(j)}−h₁₂s₂^{(j)(k)(i)}/h₁₁.

(b) Denote by s₁^{(j)(k)(i)(1)}, s₁^{(j)(k)(i)(2)}, s₁^{(j)(k)(i)(3)},s₃^{(j)(k)(i)(4)} the four (K₁=4) candidate symbols in the 16 QAM constellation closest to z₁^{(j)(k)(i)} from (a). Thus there are a total now of 256(=K₄K₃K₂K₁) candidate symbols s₁^{(j)(k)(i)(m)} and 256 candidate symbol quartets (s₄^{(j)}, s₃^{(j)(k)}, s₂^{(j)(k)(i)}, s₁^{(j)(k)(i)(m)}).

(c) Compute the error corresponding to each of the 256 candidate symbols from (b): e₁^{(j)(k)(i)(m)}=|r₁−h₁₄s₄^{(j)}−h₁₃s₃^{(j)(k)}−h₁₂s₂^{(j)(k)(i)}−h₁₁s₁^{(j)(k)(i)(m)}|².

(d) Each of the 256 total errors e₄^{(j)}+e₃^{(j)(k)}+e₂^{(i)(k)(i)}+e₁^{(j)(k)(i)(m)} corresponds to the metric for a sequence of four branches (and a quartet of candidate symbols) from the root node to a leaf. Let j=j₀, k=k₀, i=i₀, m=m₀, be the smallest total error, then the four detected symbols are: s₁^{(j}^{₀}^{)(k}^{₀}⁾⁽ⁱ^{₀}^{)(m}^{₀}⁾, s₂^{(j}^{₀}^{)(k}^{₀}⁾⁽ⁱ^{₀}⁾, s₃^{(j}^{₀}^{)(k}^{₀}⁾, and s₄^{(j}^{₀}⁾.) Thus the preferred embodiment minimizes over a set of 256 metrics as compared to the (16)⁴=64K metrics that ML minimizes over.

Also, each of the four steps could be expressed in terms of the original 4×4 triangular channel matrix with the various 4-vectors incorporating the candidates and interference cancellations. Indeed, the four steps in terms of 4×4 systems are, successively:

$$[ \begin{matrix}{r}_{1} \\ {r}_{2} \\ {r}_{3} \\ {r}_{4}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34} \\ 0 & 0 & 0 & {h}_{44}\end{matrix} ] [ \begin{matrix}{s}_{1} \\ {s}_{2} \\ {s}_{3} \\ {s}_{4}\end{matrix} ] + [ \begin{matrix}{v}_{1} \\ {v}_{2} \\ {v}_{3} \\ {v}_{4}\end{matrix} ] \\ [ \begin{matrix}{r}_{1} - {h}_{14} {s}_{4}^{( j )} \\ {r}_{2} - {h}_{24} {s}_{4}^{( j )} \\ {r}_{3} - {h}_{34} {s}_{4}^{( j )} \\ {r}_{4} - {h}_{44} {s}_{4}^{( j )}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34} \\ 0 & 0 & 0 & {h}_{44}\end{matrix} ] [ \begin{matrix}{s}_{1} \\ {s}_{2} \\ {s}_{3} \\ {s}_{4} - {s}_{4}^{( j )}\end{matrix} ] + [ \begin{matrix}{v}_{1} \\ {v}_{2} \\ {v}_{3} \\ {v}_{4}\end{matrix} ] \\ [ \begin{matrix}{r}_{1} - {h}_{14} {s}_{4}^{( j )} - {h}_{13} {s}_{3}^{( j ) ( k )} \\ {r}_{2} - {h}_{24} {s}_{4}^{( j )} - {h}_{23} {s}_{3}^{( j ) ( k )} \\ {r}_{3} - {h}_{34} {s}_{4}^{( j )} - {h}_{33} {s}_{3}^{( j ) ( k )} \\ {r}_{4} - {h}_{44} {s}_{4}^{( j )}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34} \\ 0 & 0 & 0 & {h}_{44}\end{matrix} ] [ \begin{matrix}{s}_{1} \\ {s}_{2} \\ {s}_{3} - {s}_{3}^{( j ) ( k )} \\ {s}_{4} - {s}_{4}^{( j )}\end{matrix} ] + [ \begin{matrix}{v}_{1} \\ {v}_{2} \\ {v}_{3} \\ {v}_{4}\end{matrix} ] \\ [ \begin{matrix}{r}_{1} - {h}_{14} {s}_{4}^{( j )} - {h}_{13} {s}_{3}^{( j ) ( k )} - {h}_{12} {s}_{2}^{( j ) ( k ) ( i )} \\ {r}_{2} - {h}_{24} {s}_{4}^{( j )} - {h}_{23} {s}_{3}^{( j ) ( k )} - {h}_{22} {s}_{2}^{( j ) ( k ) ( i )} \\ {r}_{3} - {h}_{34} {s}_{4}^{( j )} - {h}_{33} {s}_{3}^{( j ) ( k )} \\ {r}_{4} - {h}_{44} {s}_{4}^{( j )}\end{matrix} ] = [ \begin{matrix}{h}_{11} & {h}_{12} & {h}_{13} & {h}_{14} \\ 0 & {h}_{22} & {h}_{23} & {h}_{24} \\ 0 & 0 & {h}_{33} & {h}_{34} \\ 0 & 0 & 0 & {h}_{44}\end{matrix} ] [ \begin{matrix}{s}_{1} \\ {s}_{2} - {s}_{2}^{( j ) ( k ) ( i )} \\ {s}_{3} - {s}_{3}^{( j ) ( k )} \\ {s}_{4} - {s}_{4}^{( j )}\end{matrix} ] + [ \begin{matrix}{v}_{1} \\ {v}_{2} \\ {v}_{3} \\ {v}_{4}\end{matrix} ]$$

### The 4×4 F_{ZF} or F_{MMSE} is the same for each step, although only one row of F_{ZF} or F_{MMSE} is used in each step.

(2) Initial triangular with full last branch preferred embodiment

A first alternative follows all of the foregoing except it does not restrict the last symbol candidates to only the four nearest the soft estimate. Rather, treat all sixteen constellation elements as candidates (i.e., K₁=16) and compute all 1024 errors e₁^{(j)(k)(i)(m)} for j=1,2,3,4; k=1,2,3,4; i=1,2,3,4; and m=1,2, . . . ,16. Then find the smallest of the 1024 total errors to determine the detected four symbols.

(3) Initial triangular with single last branch preferred embodiment

Another alternative follows all of the foregoing except it restricts the last branch symbol candidates to the single symbol closest the soft estimate rather than the four closest (i.e., K₁=1). Because there will be no subsequent branches, the preferred embodiment attempts to find the minimum error final branch by minimal computation. Thus compute only the sixty-four errors e₁^{(i)(k)(i)(m)} for j=1,2,3,4; k=1,2,3,4; i=1,2,3,4; and m=1. Then find the smallest of the 64 total errors e₄^{(j)}+e₃^{(j)(k)}+e₂^{(j)(k)(i)}+e₁^{(j)(k)(i)(1)} to determine the detected sequence of four symbols ŝ₄, ŝ₃, ŝ₂, ŝ₁. This approach relies on the last branch ZF or MMSE soft estimate z₁=(r₁−h₁₄s₄^{(j)}−h₁₃s₃^{(j)(k)}−h₁₂s₂^{(j)(k)(i)}/h₁₁ and so the closest symbol s₁^{(j)(k)(i)(1) to z}₁ minimizes |z₁−s₁^{(j)(k)(i)(m)}|² which thus also minimizes e₁^{(j)(k)(i)(m)}=|h₁₁(z₁−s₁^{(j)(k)(i)(m)})|²=|r₁−h₁₄s₄^{(j)}−h₁₃s₃^{(j)(k)}−h₁₂s₂^{(j)(k)(i)}−h₁₁s₁^{(j)(k)(i)(m)}|². That is, the smallest of the last branch errors is just the one associated with the candidate symbol closest to the soft estimate.

(4) SINR-ordered full triangular preferred embodiments

A second alternative follows any of the foregoing (1)-(3) but prior to the initial triangularizing unitary matrix U, the method applies LZF or LMMSE filter to estimate the symbol signal-to-interference-plus-noise ratios (SINR) for each of the symbols, and the method permutes the antennas indices to have s₁, s₂, s₃, s₄ be in increasing SINR order. Then the unitary (or other) matrix is found and applied. This should decrease error feedback due to an increased probability that the first branch candidates include the actual transmitted s₄ symbol.

(5) Sequential rotation preferred embodiments

Rather than initially full triangularizing H, just find a rotation U₄ to make h₄₁=h₄₂=h₄₃=0; this suffices to compute the candidate S4 ) error in received-signal space, cancel its interference, and reduce the 4×4 system to a 3×3 system as in the previous methods (1)-(4). Again, the detection will be in order s₄, s₃, s₂, s₁ with K₄=K₃=K₂=K₁=4. However, as in method (4), first estimate the SINR for each of the symbols and, next, permute the indices so that s₄ has the largest SINR. Then find a 4×4 unitary matrix U₄ and left-multiply to yield the 4×4 system:

$$[ \begin{matrix}{r}_{1} \\ {r}_{2} \\ {r}_{3} \\ {r}_{4}\end{matrix} ] = [ \begin{matrix}{h}_{11} & {h}_{12} & {h}_{13} & {h}_{14} \\ {h}_{21} & {h}_{22} & {h}_{23} & {h}_{24} \\ {h}_{31} & {h}_{32} & {h}_{33} & {h}_{34} \\ 0 & 0 & 0 & {h}_{44}\end{matrix} ] [ \begin{matrix}{s}_{1} \\ {s}_{2} \\ {s}_{3} \\ {s}_{4}\end{matrix} ] + [ \begin{matrix}{v}_{1} \\ {v}_{2} \\ {v}_{3} \\ {v}_{4}\end{matrix} ]$$

Again, if h₄₄=0, then the system is degenerate and all four symbols cannot be detected. If U₄^{H}=[u₁, u₂, u₃, u₄], then the requirement for U₄ is simply to have u₄ orthogonal to the original h₁, h₂, h₃ (i.e., <u₄|h₁>=<₄|h₂>=<u₄|h₃>=0) which means that u₁, u₂, u₃ can be any orthonormal set in the span of the original h₁, h₂, h₃.

Initial symbol detection. (a) Start with s₄: find the soft estimate z₄ from the linear z=Fr with F either the LZF filter or the LMMSE filter. The LZF filter is simple:

$${F}_{ZF} = [ \begin{matrix}- & - & - & - \\ - & - & - & - \\ - & - & - & - \\ 0 & 0 & 0 & 1 / {h}_{44}\end{matrix} ]$$

where the non-bottom-row elements (cofactors divided by the determinant) are not explicitly shown for clarity. F_{ZF} immediately gives: z₄=r₄/h₄₄. The LMMSE filter, F_{MMSE}, is not as simple and is z₄=f₄₁r₁+f₄₂r₂+f₄₃r₃+f₄₄r₄ where [f₄₁,f₄₂,f₄₃, f₄₄] is the fourth row of F_{MMSE}.

(b) Denote by s₄⁽¹⁾, s₄⁽²⁾, s₄⁽³⁾, s₄⁽⁴⁾ the four (K₄=4) candidate symbols in the 16 QAM constellation closest to z₄ from (a). That is, the four smallest |z₄−s₄|² out of the sixteen possible s₄s.

(c) Compute the error corresponding to each of the four candidate symbols from (b): e₄⁽¹⁾=|r₄−h₄₄s₄⁽¹⁾|², e₄⁽²⁾=|r₄−h₄₄s₄⁽²⁾|², e₄⁽³⁾=|r₄−h₄₄s₄⁽³⁾|², e₄⁽⁴⁾=|r₄−h₄₄s₄⁽⁴⁾|², The special form of the bottom row of the H matrix allows this error computation to avoid involving the yet-to-be-considered symbols.

(d) For each of the four candidate symbols, cancel the interference in r from that candidate symbol to give a new 3×3 system for the remaining symbols s₃, s₂, s₁. That is, delete the fourth component of r and the fourth row of H because they only contained 54 information and candidates for s₄ have just been chosen; the candidate value is used in s. Thus for each j=1,2,3,4:

$$[ \begin{matrix}{r}_{1} - {h}_{14} {s}_{4}^{( j )} \\ {r}_{2} - {h}_{24} {s}_{4}^{( j )} \\ {r}_{3} - {h}_{34} {s}_{4}^{( j )}\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{s}_{1} \\ {s}_{2} \\ {s}_{3}\end{matrix} ] + [ \begin{matrix}{v}_{1} \\ {v}_{2} \\ {v}_{3}\end{matrix} ]$$

Next symbol detection: (a) As for the initial symbol detection, first find a rotation U₃ to make the last row simple: h₃₁=h₃₂=0. Again, this will allow cancellation the candidate s₃^{(j)(k)} interference and reduce the 3×3 system to a 2×2 system as in the previous methods (1)-(4). Also, as for the initial symbol detection, first estimate the SINR of the remaining symbols and permute the indices so that s₃ has the largest SINR prior to finding U₃. Note that each of the four 3×3 systems (for j=1,2,3,4) has its own SINRs and thus the four U₃s may differ. But in each case after the U₃ rotation the 3×3 system has the form:

$$[ \begin{matrix}{r}_{1} - {h}_{14} {s}_{4}^{( j )} \\ {r}_{2} - {h}_{24} {s}_{4}^{( j )} \\ {r}_{3} - {h}_{34} {s}_{4}^{( j )}\end{matrix} ] = [ \begin{matrix}{h}_{11} & {h}_{12} & {h}_{13} \\ {h}_{21} & {h}_{22} & {h}_{23} \\ 0 & 0 & {h}_{33}\end{matrix} ] [ \begin{matrix}{s}_{1} \\ {s}_{2} \\ {s}_{3}\end{matrix} ] + [ \begin{matrix}{v}_{1} \\ {v}_{2} \\ {v}_{3}\end{matrix} ]$$

(b) For s₃ in the 3×3 system corresponding to s₄^{(j)}: find the soft estimate z₃^{(j)} from the linear z^{(j)=Fr}^{(j)} with F either the LZF filter or the LMMSE filter for the 3×3 matrix with the simple last row.

(c) Denote by s₃^{(j)(1)}, s₃^{(j)(2)}, s₃^{(j)(3), s}₃^{(j)(4)} the four (K₃=4) candidate symbols in the 16 QAM constellation closest to z₃^{(j)} from (b). That is, the four smallest |z₃^{(j)}−s₃|² out of the sixteen possible. As before, there are a total now of sixteen candidate symbols s₃^{(j)(k)} and symbol pairs (s₄^{(j)}, s₃^{(j)(k)}).

(d) Compute the error corresponding to each of the sixteen candidate symbols from (b): e₃^{(j)(k)}=|r₃−h₃₄s₄^{(j)}−h₃₃s₃^{(j)(k)}|². Again, the simple bottom row matrix allows for an error computation without involving the yet-to-be-considered symbols s₂, s₁.

(e) For each of the sixty-four candidate symbols from (c), cancel the interference in r from that candidate symbol to give a new 2×2 system for the remaining symbols s₂, s₁. That is, delete the third component of r and the third row of the 3×3 H because they only contained s₃ information and candidates for s₃ have just been chosen; the candidate value is used in s. Thus for each j=1,2,3,4 and k=1,2,3,4:

$$[ \begin{matrix}{r}_{1} - {h}_{14} {s}_{4}^{( j )} - {h}_{13} {s}_{3}^{( j ) ( k )} \\ {r}_{2} - {h}_{24} {s}_{4}^{( j )} - {h}_{23} {s}_{3}^{( j ) ( k )}\end{matrix} ] = [ \begin{matrix}{h}_{11} & {h}_{12} \\ {h}_{21} & {h}_{22}\end{matrix} ] [ \begin{matrix}{s}_{1} \\ {s}_{2}\end{matrix} ] + [ \begin{matrix}{v}_{1} \\ {v}_{2}\end{matrix} ]$$

So each candidate s₃^{(j)(k)} has an error measure and a 2×2 system for the remaining symbols. In terms of the tree, each candidate pair corresponds to a sequence of two branches from the root node to a first level node to a second level node, the 2×2 system corresponds to the portion of the tree from the second level node to the leaves, and the candidate's error corresponds to the metric for the second branch so the sum of errors e₄^{(j)}+e₃^{(j)(k)} corresponds to the metric for the pair of branches. There are sixteen (=K₄K₃) sequences of two branches from the root node to second level nodes.

Third symbol detection. (a) As with the prior two symbol detections, first estimate the SINRs for the remaining (two) symbols, permute the indices to make s₂ the symbol with the larger SINR prior to finding U₂. Note that each of the sixteen 2×2 systems (for j=1,2,3,4, k=1,2,3,4) has its own SINRs and thus the sixteen U₂s may differ. But in each case after the U₂ rotation the 2×2 system has the form:

$$[ \begin{matrix}{r}_{1} - {h}_{14} {s}_{4}^{( j )} - {h}_{13} {s}_{3}^{( j ) ( k )} \\ {r}_{2} - {h}_{24} {s}_{4}^{( j )} - {h}_{23} {s}_{3}^{( j ) ( k )}\end{matrix} ] = [ \begin{matrix}{h}_{11} & {h}_{12} \\ 0 & {h}_{22}\end{matrix} ] [ \begin{matrix}{s}_{1} \\ {s}_{2}\end{matrix} ] + [ \begin{matrix}{v}_{1} \\ {v}_{2}\end{matrix} ]$$

(b) For s₂ in the 2×2 system corresponding to s₃^{(j)(k)}: find the soft estimate z₂^{(j)(k)}from the linear z^{(j)(k)=Fr}^{(j)(k)} with F either the LZF filter or the LMMSE filter for the 2×2 triangular matrix. Note that these 2×2 systems are the same as in the prior methods (1)-(4) because the matrix is now fully triangular. Thus proceeds as in any of the prior methods for the last two symbol detections.

(6) Threshold for Kₘ preferred embodiments

In any of the foregoing symbol detection examples, when the four candidates are determined as the four closest symbols to the soft estimate, a further alternative method simplify the computations by discarding ones of the candidates which are not close enough to the soft estimate when compared to the closest candidate. For example, if |z₄−s₄⁽¹⁾|² is the smallest and |a₄−s₄^{(4)|}² is the fourth smallest, and if 3|z₄−s₄⁽¹⁾|²<|z₄−s₄⁽⁴⁾|² then discard s₄⁽⁴⁾ and only use three branches. In effect, Kₘ becomes adaptive and decreases when the ZF or MMSE hard estimate is very close to the soft estimate (the branch error is very small); this dynamically prunes the tree.

(7) Received-signal candidate selection preferred embodiments

In the foregoing preferred embodiments at each step the candidate symbols were picked by closeness to the soft estimate, and then the errors are computed. An alternative at each step computes the errors for all branches from each current node, and then picks the Kₘ candidate symbols as those yielding the Kₘ smallest errors. For the 4×4 example, in the first step compute the error for each of the 16 symbols of 16 QAM: e₄^{(j)}=|r₄31 h₄₄s₄^{(j)}|² for j=1, 2, . . . ,16. Then the four smallest errors determine the candidate symbols (reindexed): s₄⁽¹⁾, s₄⁽²⁾, s₄⁽³⁾, s₄⁽⁴⁾. Note that no soft estimate was needed. In the second step, for each four first step candidate symbols, s₄^{(j)}, j=1, 2, 3, 4, compute the next-branch error for each of the 16 symbols of 16 QAM: e₃^{(j)(k)}=|r₃−h₃₄s₄^{(f)}−h₃₃s₃^{(j)(k)}|² for k=1, 2, . . . ,16. Then for each set of 16 errors, the four smallest errors determine the candidate symbols (reindexed): s₃^{(j)(1)}, s₃^{(j)(2)}, s₃^{(j)(3)}, s₃^{(j)(4)}. Thus a total of 16 pairs of candidate symbols, (s₄^{(j)}, s₃^{(j)(k)}) with both indexes in the range 1,2,3,4. Repeat for the third step; this yields 64 triplets of candidate symbols, (s₄^{(j)}, s₃^{(j)(k)}, s₂^{(j)(k)(m)}) with each index in the range 1,2,3,4. In the fourth (final) step, only the smallest error of each of the 64 sets of 16 errors is needed; this yields 64 quartets of candidate symbols, (s₄^{(j)}, s₃^{(j)(k)}, s₂^{(j)(k)(m)}, s₁^{(j)(k)(m)(1)}), with each index j,k,m in the range 1,2,3,4. The quartet with the smallest total error (e₄^{(j)}+e₃^{(j)(k)}+e₂^{(j )(k)(m)+e}₁^{(j)(k)(m)(1)}) is then the detected set of four symbols. The computations were 16 errors in the first step, 64 errors in the second step, 256 errors in the third step, 1024 errors in the fourth step. This is roughly 2% of the complexity of ML.

A variation of this candidate selection from 16 error computations is in the fourth (final) step: simply use hard estimates from the soft estimates to pick the 64 candidates s₁^{(i)(k)(m)(1)}), and then compute only the corresponding 64 errors rather than the 1024 errors to use in the total error minimization.

### 6. Experimental Results

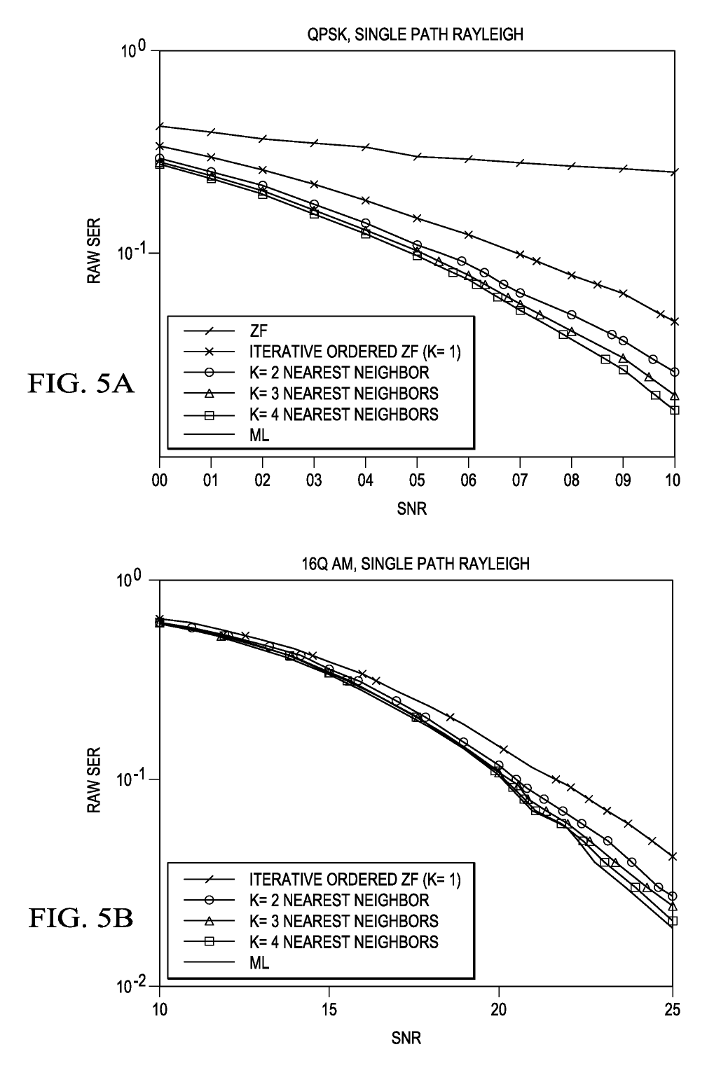

FIGS. 5a-5b show the performance of a preferred embodiment method as compared to the ML method. The IZF method of was used to obtain the starting point. FIG. 5b shows that at most 4 candidates are needed to obtain close to ML performance for the 16 QAM constellation. FIG. 5a also shows that the performance for the 4 QAM (QPSK) case with K₂=4 candidtes is the same as the ML method (this is obvious because there are only 4 constellation points).

What is claimed is:

1. A method of decoding, comprising:
(a) receiving a plurality of input coded streams;
(b) decoding a first of said streams to yield K differing constellation points together with K errors where K is an integer greater than 1 but less than the number of points in a constellation for said first stream;
(c) cancelling each of said K decoded first stream constellation points from said input coded streams to yield K systems of interference cancelled input coded streams;
(d) for each of said K systems from said step (c), decoding a second of said streams to M differing constellation points together with M errors where M is an integer greater than 0 to yield KM systems of interference cancelled input coded streams with each system having a sum of errors corresponding to the error for said constellation point for said first stream and the error for said constellation point for said second stream; and
(e) selecting a constellation point for said first stream and a constellation point for said second stream using said sums of errors.

2. A MIMO receiver, comprising:
(a) a first plurality of antennas for receiving a second plurality of transmitted encoded streams;
(b) a decoder coupled to said antennas, said decoder operable to:
(i) decode a first of said streams to yield K differing constellation points together with K errors where K is an integer greater than 1 but less than the number of points in a constellation for said first stream;
(ii) cancel each of said K decoded first stream constellation points from said coded streams to yield K systems of interference cancelled coded streams;
(iii) for each of said K systems from said step (c), decode a second of said streams to M differing constellation points together with M errors where M is an integer greater than 0 to yield KM systems of interference cancelled coded streams with each system having a sum of errors corresponding to the error for said constellation point for said first stream and the error for said constellation point for said second stream; and
(iv) select a constellation point for said first stream and a constellation point for said second stream using said sums of errors
